(19) United States
(12) Patent Application Publication
(10) Pub. No.: US 2021/0025402 A1
(43) Pub. Date: Jan. 28, 2021

(54) CLUTCH COOLING WITH BLADED ROTATABLE SHAFT

(71) Applicant: GM GLOBAL TECHNOLOGY OPERATIONS LLC, Detroit, MI (US)

(72) Inventors: Demetrio Vettorazzo Neto, Santo Andre (BR); Ricardo S. Peres, Sao Paulo (BR)

(21) Appl. No.: 16/517,899

(22) Filed: Jul. 22, 2019

(51) Int. Cl. F04D 27/00; F16D 13/72; F16H 57/04; F04D 25/06

(52) U.S. Cl. CPC F04D 27/006; F04D 25/06; F16H 57/0416; F16D 13/72

(57) ABSTRACT

A cooling system for an automotive transmission is provided. The cooling system includes a housing defining a housing inlet. The housing defines an interior space that is in fluid communication with the housing inlet. A propeller assembly has a rotatable shaft and a blade extending from the rotatable shaft, which is configured to draw ambient air into the interior space of the housing through the housing inlet. A propulsion system assembly includes an engine configured to provide propulsion power through an engine output and an automotive transmission configured to receive the propulsion power from the engine output. A clutch is configured to selectively couple the engine output to the automotive transmission. The clutch is disposed in a housing, where the housing defines an ambient air inlet. A rotatable shaft having a blade is configured to draw ambient air into the housing through the ambient air inlet to cool the clutch.

### FIELD

The present invention relates to a cooling system for an automotive propulsion system.

### INTRODUCTION

A typical automotive propulsion system includes an engine and a transmission bolted to the engine. Transmissions may be of various types, such as automatic, manual, or a hybrid of the two. Some may have stepped gear ratios, while others are continuously variable.

Automotive manual transmissions employ synchronizer torque-transmitting mechanisms to establish torque paths from a transmission input shaft to a transmission output shaft. Manual transmissions are generally countershaft-type transmissions wherein one of the first ratio gears is disposed on a main or central shaft and the other first ratio gear that meshes with the first ratio gear is supported on a countershaft parallel with the main shaft. The ratio gears mesh such that a plurality of gear ratios can be established between the input shaft and the output shaft with the power flow passing through the main shaft and countershaft.

A manual clutch is used to selective connect the engine output to the transmission shaft. The manual clutch is typically disengaged while changing between gear ratios within the manual transmission. The manual clutch is relatively large, having a diameter similar to the diameter of the transmission. The manual clutch may have discs with friction lining material and a pressure plate that is considerably thick to withstand heat loads. The manual clutch assembly is sized to withstand high heat loads, especially while traveling up a hilly terrain with frequenting stopping and going. However, the large size of the manual clutch assembly presents other challenges, such as added weight. In addition, high heat to the manual clutch assembly may cause wear and early failure.

### SUMMARY

The present disclosure provides a cooling system that uses a bladed rotatable shaft to create air circulation within the housing surrounding the manual transmission clutch to reduce clutch temperatures. Cooling the clutch in this manner can allow for a clutch design having reduced mass, cost, package, and warranty claims.

In one form, which may be combined with or separate from other forms disclosed herein, a cooling system for an automotive transmission of a motor vehicle is provided. The cooling system includes a housing defining a housing inlet, where the housing defines an interior space that is in fluid communication with the housing inlet. The system also includes a propeller assembly having a rotatable shaft and a blade extending from the rotatable shaft. The propeller assembly is configured to draw ambient air into the interior space of the housing through the housing inlet.

In another form, which may be combined with or separate from the other forms disclosed herein, a propulsion system assembly is provided that includes an engine configured to provide propulsion power through an engine output and an automotive transmission configured to receive the propulsion power from the engine output. A clutch is configured to selectively couple the engine output to the automotive transmission. The clutch is disposed in a housing. The housing defines an ambient air inlet. A propeller assembly has a rotatable shaft and a blade extending from the rotatable shaft. The propeller assembly is configured to draw ambient air into the housing through the ambient air inlet to cool the clutch.

In yet another form, which may be combined with or separate from the other forms disclosed herein, an automotive propulsion system is provided that includes an engine configured to provide propulsion power through an engine output and an automotive transmission configured to receive the propulsion power from the engine output. A clutch is configured to selectively couple the engine output to the automotive transmission. A bell housing is attached to an end of the automotive transmission. The clutch is disposed within the bell housing. The bell housing defines an ambient air inlet and an air outlet. An engine starter motor assembly is configured to initiate operation of engine. The engine starter motor assembly has a motor, a rotatable shaft, and first and second solenoids. The first solenoid is configured to actuate the motor to drive the rotatable shaft, and the second solenoid is configured to couple the rotatable shaft to an engine input. The rotatable shaft extends into the bell housing. At least one blade extends from the rotatable shaft, where the blade(s) are disposed in the bell housing. The rotatable shaft and blade(s) are configured to draw ambient air into the bell housing through the ambient air inlet to cool the clutch.

Additional features may optionally be provided, including but not limited to the following: a motor configured to drive rotation of the rotatable shaft to draw the ambient air into the interior space of the housing; a solenoid configured to selectively drive the motor to rotate the rotatable shaft; the system (e.g., by way of a controller) being configured to determine whether a determined air temperature within the housing exceeds a predetermined threshold; the solenoid being configured to actuate the motor to rotate the rotatable shaft when the determined air temperature within the housing exceeds the predetermined threshold; the motor being an engine starter motor configured to initiate operation of an engine; a temperature sensor configured to measure the air temperature within the housing; the determined air temperature being an air temperature measured by the temperature sensor; the determined air temperature being estimated or calculated based on parameters other than the measured air temperature within the housing; the housing defining a housing outlet in fluid communication with the interior space; the propeller assembly being configured to draw ambient air into the interior space of the housing through the housing inlet to define a cooling air flow path from the housing inlet, through the interior space of the housing, and out of the housing outlet; the housing being a bell housing of an automotive transmission; a clutch assembly disposed within the bell housing; and the cooling air flow path being disposed in such proximity to the clutch assembly as to provide a cooling effect on the clutch assembly.

Further examples, aspects and advantages of the present disclosure will become apparent by reference to the following description and appended drawings wherein like reference numbers refer to the same component, element or feature.

### BRIEF DESCRIPTION OF THE DRAWINGS

The drawings described herein are for illustration purposes only and is not intended to limit the scope of the present disclosure in any way.

FIG. 1 is a schematic view of an automotive propulsion system having a cooling system, in accordance with the principles of the present disclosure.

### DETAILED DESCRIPTION

The present disclosure provides an automotive propulsion system having an improved cooling system that uses a bladed rotor or propeller to draw or pump cooling ambient air into the transmission housing portion that contains the manual clutch, to reduce clutch temperatures. Cooling the clutch in this manner can allow for a clutch design having reduced mass, cost, package, and warranty claims.

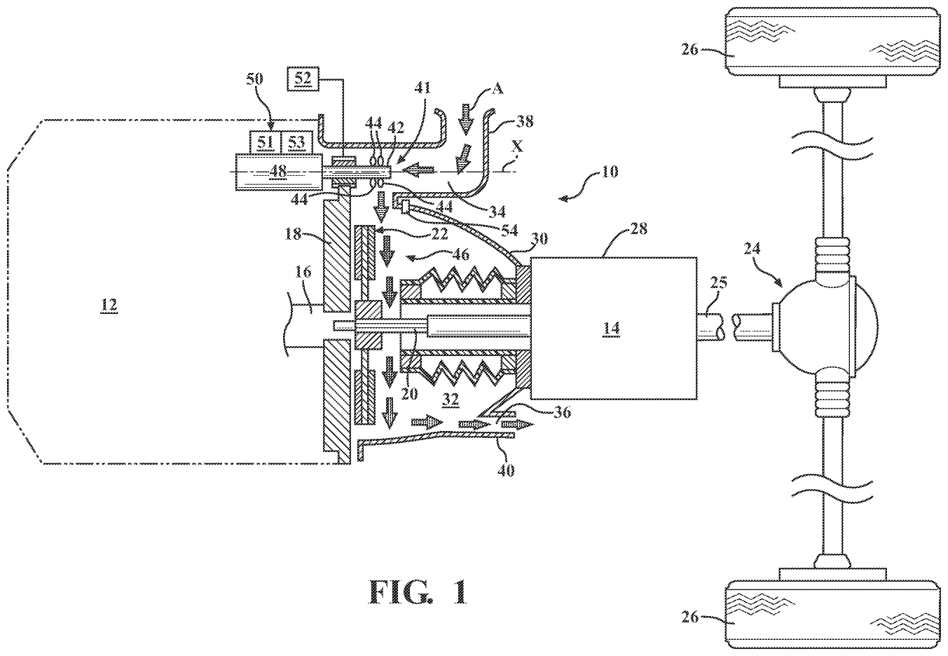

With reference to FIG. 1, a schematic diagram shows an automotive propulsion system generally indicated by reference number 10. It should be appreciated at the outset that while a rear-wheel drive propulsion system 10 has been illustrated, the propulsion system 10 could alternatively be adapted for front-wheel drive, all-wheel drive, or four-wheel drive propulsion system, without departing from the scope of the present disclosure.

The propulsion system 10 generally includes an engine 12 that is selectively interconnected with a transmission 14, which may be further connected with a final drive unit 24. The engine 12 may be a conventional internal combustion engine, a hybrid engine, or any other type of prime mover, without departing from the spirit and scope of the present disclosure. The engine 12 supplies a driving engine output torque to the transmission 14 via an output, which may be in the form of a crankshaft 16 connected to a flywheel 18. The crankshaft 16 may rotate to provide propulsion power to the transmission 14 through a transmission input shaft 20, where the crankshaft 16 and flywheel 18 are selectively connected to the input shaft 20 through a selective coupling device such as a manual transmission clutch assembly 22. Thus, the clutch assembly 22 is configured to selectively couple the engine 12 to the transmission 14.

The transmission 14 may be a stepped transmission having planetary gears, a countershaft transmission, a continuously variable transmission, or an infinitely variable transmission. In the illustrated example, the transmission 14 is a manual transmission having a plurality of shafts and synchronizer gears (not shown) configured to transmit torque from the input shaft 20 to an output shaft 25 and ultimately to the final drive assembly 24 and a set of wheels 26. Torque from the transmission input shaft 20 is communicated through the shafts and synchronizer gears to the transmission output shaft 25, where the combinations and connections of the shafts and synchronizer gears can be changed to change the speed ratio of the input shaft 20 to the output shaft 25. The transmission 14 includes a transmission case main part 28 attached to a bell housing 30, which form a housing for the transmission 14. The manual clutch assembly 22 is generally disposed in an interior space 32 of the transmission 14 defined by the bell housing 30.

In this example, the bell housing 30 defines a housing inlet 34 and a housing outlet 36 for air to travel through, as will be explained in further detail below. In the alternative, housing inlet 34 and outlet 36 could be formed in the main part of the transmission case 28 or in a housing of the engine 12. The housing inlet 34 and outlet 36 may or may not include associated tubing structure. In other words, the inlet 34 may include an inlet tube 38, or the inlet 34 may simply be an opening in the bell housing 30 or other housing structure. Similarly, the outlet 36 may include an outlet tube 40, or the outlet 36 may simply be an opening in the bell housing 30 or other housing structure. The inlet 34 and outlet 36 may be directly open to outside air, or either may be connected to further structure within the vehicle. For example, the outlet 36 could be connected to an engine exhaust pipe (not shown). In this example, the housing inlet 34 and the outlet 36 are in fluid communication with the interior space 32 defined by the bell housing 30.

The propulsion system 10 further includes a propeller assembly 41 that includes a rotatable shaft 42 having one or more blades 44 extending therefrom. The blades 44 may be fixedly attached to the rotatable shaft 42. The propeller assembly 41 is configured to rotate to draw or pump ambient air into the interior space 32 of the bell housing 30 through the housing inlet 34. As the rotatable shaft 42 is rotated about a central axis X of the rotatable shaft 42, the blade(s) 44 operate to pump ambient air from outside of the transmission 14 and bell housing 30 through the inlet 34 and into the interior space 32 defined by the bell housing 30, and then the air exits the bell housing 30 through the outlet 36. A cooling air flow path 46 is thus established from the housing inlet 34, through the interior space 32 of the bell housing 30 and past the clutch assembly 22, and out of the housing outlet 36.

As cooling air A (which may be ambient air) travels along the cooling air flow path 46, the cooling air A is warmed by the heat in the interior space 32 of the bell housing 30, where the heat may originate with the clutch assembly 22. Accordingly, as shown by the arrows of the cooling air A in FIG. 1, the cooling air A starts off at a cool ambient temperature (shown with blue cross-hatching) and is heated along the flow path 46, shown with yellow cross-hatching as the cooling air A starts to heat up and with red cross-hatching when the cooling air A becomes relatively hot. The cooling air flow path 46 is disposed in such proximity to the clutch assembly 22 as to provide a cooling effect on the clutch assembly 22.

Thus, a cooling system is established by placing the housing inlet 34 and outlet 36 in fluid communication with the interior space 32 of the bell housing 30 and by introducing a propeller assembly 41 to act as a fan or pump to bring the cooling air A from outside of the bell housing 30 into the interior space 32 of the bell housing 30.

The cooling systems of the present disclosure are thus configured to create the cooling air path 46 to flow past the clutch assembly 22 and remove heat from the clutch assembly 22, thereby cooling the clutch assembly 22 and reducing the working temperature of the clutch assembly 22. With a lower working temperature, the clutch design can be simplified, for example, by using less expensive clutch lining material and less mass, leading to a reduction in cost. A more compact clutch design can be used for the clutch assembly 22, and as a result, a more compact transmission 14 and propulsion system 10 can be achieved. Furthermore, warranty claims may be reduced by protecting clutch system endurance and integrity by virtue of the cooling system described herein. When the clutch mass is reduced, clutch inertia may be reduced, which is beneficial to operation of the synchronizers of a manual transmission during gear shifts because the shifts are not as hard on the synchronizers.

In the illustrated example, a starter motor 48 is provided, which is typically used to initiate operation of the engine 12. In this example, the rotatable shaft 42 is part of the starter motor 48, and the starter motor 48 is configured to drive rotation of the rotatable shaft 42 to draw the ambient air A into the interior space 32 of the bell housing 30. In other variations, however, the rotatable shaft 42 could be driven by a different motor or simply by air contacting the blades 44.

The starter motor 48 includes a solenoid 50. The solenoid 50 may be configured to selectively operate the starter motor 48, which drives the rotatable shaft 42, so that the rotation of the rotatable shaft 42 may be controlled by the solenoid 50.

In the illustrated example, the solenoid 50 is a dual solenoid or tandem solenoid having two solenoids 51, 53. One of the solenoids 53 actuates the starter motor 48 and drives the rotatable shaft 42, while the other solenoid 51 activates the pinion shift to couple the starter motor 48 to the engine 12. The tandem solenoid 50 is typically located on the top of the starter motor 48, but the tandem solenoid 50 could alternatively be located elsewhere.

In some examples, the propulsion system 10 may utilize a determined air temperature within the interior space 32 of the bell housing 30 to control rotation of the of the rotatable shaft 42. For example, when the determined air temperature is above a predetermined threshold, the motor solenoid 53 may actuate the starter motor 48 to drive and rotate the rotatable shaft 42. The tandem solenoid 50 can be configured to avoid actuating the pinion shift solenoid 51, so as not to connect the starter motor 48 to the engine 48 when the rotatable shaft 42 is being used for cooling the clutch (i.e., when the temperature is above the threshold). In this example, when the determined air temperature is below (or not above) the predetermined threshold, the solenoid 53 is not actuated to drive the starter motor 48 and rotate the rotatable shaft 42 in a disengaged position of the solenoid 50, unless the starter motor 48 is being used to start the engine 12. A controller 52 may be configured to cause the motor solenoid 53 to activate and deactivate the motor 48, to selectively cause rotation of the rotatable shaft 42.

Thus, the controller 52 may be configured to determine whether the determined air temperature within the interior space 32 of the bell housing 30 exceeds the predetermined threshold. The determined air temperature may be measured or estimated. For example, a temperature sensor 54 may be included and configured to directly measure the air temperature within the interior space 32 of the bell housing. The measured air temperature may be used as the determined air temperature by the controller 52 to determine whether to actuate the motor solenoid 53 to drive the rotatable shaft 42 of the propeller assembly 41. In the alternative, however, the determined air temperature may be estimated or calculated based on parameters other than the measured air temperature within the interior space 32 of the bell housing 30, such as based on pressure data.

The description herein is merely exemplary in nature and variations that do not depart from the gist of the disclosure are intended to be within the scope of the disclosure. Such variations are not to be regarded as a departure from the spirit and scope of the disclosure.

What is claimed is:

1. A cooling system for an automotive transmission of a motor vehicle, the cooling system comprising:
a housing defining a housing inlet, the housing defining an interior space that is in fluid communication with the housing inlet; and
a propeller assembly having a rotatable shaft and a blade extending from the rotatable shaft, the propeller assembly being configured to draw ambient air into the interior space of the housing through the housing inlet.

2. The cooling system of claim 1, further comprising a motor configured to drive rotation of the rotatable shaft to draw the ambient air into the interior space.

3. The cooling system of claim 2, further comprising a solenoid configured to selectively drive the motor to rotate the rotatable shaft.

4. The cooling system of claim 3, the cooling system being configured to determine whether a determined air temperature within the interior space exceeds a predetermined threshold, the solenoid being configured to actuate the motor to rotate the rotatable shaft when the determined air temperature within the interior space exceeds the predetermined threshold.

5. The cooling system of claim 4, the motor being an engine starter motor.

6. The cooling system of claim 5, further comprising a temperature sensor configured to measure the air temperature within the interior space, the determined air temperature being a measured air temperature measured by the temperature sensor.

7. The cooling system of claim 5, wherein the determined air temperature is estimated based on parameters other than a measured air temperature within the interior space.

8. The cooling system of claim 5, the housing defining a housing outlet in fluid communication with the interior space, the propeller assembly being configured to draw ambient air into the interior space of the housing through the housing inlet to define a cooling air flow path from the housing inlet, through the interior space of the housing, and out of the housing outlet.

9. The cooling system of claim 8, wherein the housing is a bell housing of an automotive transmission.

10. The cooling system of claim 9, further comprising a clutch assembly disposed within the bell housing, the cooling air flow path being disposed in such proximity to the clutch assembly as to provide a cooling effect on the clutch assembly.

11. A propulsion system assembly comprising:
an engine configured to provide propulsion power through an engine output;
an automotive transmission configured to receive the propulsion power from the engine output;
a clutch configured to selectively couple the engine output to the automotive transmission;
a housing in which the clutch is disposed, the housing defining an ambient air inlet; and
a propeller assembly having a rotatable shaft and a blade extending from the rotatable shaft, the propeller assembly being configured to draw ambient air into the housing through the ambient air inlet to cool the clutch.

12. The propulsion system of claim 11, further comprising a motor configured to drive rotation of the rotatable shaft to draw the ambient air into the housing.

13. The propulsion system of claim 12, further comprising a solenoid configured to selectively drive the motor to rotate the rotatable shaft.

14. The propulsion system of claim 13, further comprising a controller configured to determine whether a determined air temperature within the housing exceeds a predetermined threshold, the controller being configured to cause the solenoid to actuate the motor to rotate the rotatable when the determined air temperature within the housing exceeds the predetermined threshold.

15. The propulsion system of claim 14, the motor being an engine starter motor configured to initiate operation of the engine.

16. The propulsion system of claim 15, further comprising a temperature sensor configured to measure the air temperature within the housing, the determined air temperature being a measured air temperature measured by the temperature sensor.

17. The propulsion system of claim 15, wherein the determined air temperature is estimated based on parameters other than a measured air temperature within the housing.

18. The propulsion system of claim 15, the housing defining a housing outlet, the propeller assembly being configured to draw ambient air into the housing through the housing inlet to define a cooling air flow path from the housing inlet, through the housing past the clutch, and out of the housing outlet.

19. The propulsion system of claim 18, wherein the housing is a bell housing attached to an end of the automotive transmission.

20. An automotive propulsion system comprising:
an engine configured to provide propulsion power through an engine output;
an automotive transmission configured to receive the propulsion power from the engine output;
a clutch configured to selectively couple the engine output to the automotive transmission;
a bell housing attached to an end of the automotive transmission, the clutch being disposed within the bell housing, the bell housing defining an ambient air inlet and an air outlet;
an engine starter motor assembly configured to initiate operation of engine, the engine starter motor assembly having a motor, a rotatable shaft, and first and second solenoids, the first solenoid being configured to actuate the motor to drive the rotatable shaft, the second solenoid being configured to couple the rotatable shaft to an engine input, the rotatable shaft extending into the bell housing; and
at least one blade extending from the rotatable shaft and being disposed in the bell housing, the rotatable shaft and the at least one blade being configured to draw ambient air into the bell housing through the ambient air inlet to cool the clutch.
